(19) United States
(12) Patent Application Publication
(10) Pub. No.: US 2008/0018673 A1
(43) Pub. Date: Jan. 24, 2008

(54) Display element having substantially equally spaced human visual system (HVS) perceived lightness levels

(76) Inventors: Peter James Fricke, Corvallis, OR (US); Eric L. Ahivin, Corvallis, OR (US); Joseph W. Stellbrink, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/492,168

(22) Filed: Jul. 24, 2006

(51) Int. Cl. G09G 5/02

(52) U.S. Cl. 345/694

(57) ABSTRACT

A display element corresponds to a display of a pixel. The display element includes a number of sub-pixel regions. Each sub-pixel region has two states, including an on state and an off state. Each sub-pixel region has an area. The display has a defined area that is turned on to provide maximum lightness and that encompasses at least one of the areas of the sub-pixel regions. The ratio of the area of each sub-pixel region to the defined area of the display element is selected to provide for the display element having a number of substantially equally spaced human visual system (HVS) perceived lightness levels.

### BACKGROUND

The most common type of display device requires the individual display elements of the display device to be refreshed a number of times per second to maintain the picture being displayed. If power is removed from the display device, then no picture can be displayed on the display device. Another type of display device is one that only requires that power be provided to the display device when the picture displayed on the device is modified or changed. Otherwise, a static image remains displayed on the display device substantially indefinitely even in the absence of power to the display device.

Within display devices, typically luminance levels are controlled in a linear manner. For instance, a given display element may be controlled to provide a certain luminance level that is one-fourth, one-half, or three-quarters of the maximum luminance level that the display element is capable of displaying. However, such linear control of luminance level does not take into account the human visual system (HVS). The human eye is unable to discern changes in higher luminance levels as well as it can discern changes in lower luminance levels, for instance.

As a result, while in actuality a given display element may be provided with a number of linearly separated luminance levels, the human eye may not be able to recognizably properly (i.e., linearly) discern all of these different levels. Thus, in effect the display element is perceived to have non-linearly separated luminance levels. In real terms, this means that images displayed by display devices using such display elements may not be of as perceived quality by users as their technical specifications suggest.

### BRIEF DESCRIPTION OF THE DRAWINGS

FIG. 1 is a diagram of a display element, according to the prior art.

FIG. 2 is a graph depicting the non-linear relationship between luminance and human visual system (HVS) perceived lightness.

FIG. 3 is a diagram of a display element that employs the non-linear relationship between luminance and HVS perceived lightness of FIG. 2, according to an embodiment of the invention.

FIG. 4 is a diagram of a display element that employs the non-linear relationship between luminance and HVS perceived lightness of FIG. 2, according to another embodiment of the invention.

FIG. 5 is a diagram of a rudimentary display device, according to an embodiment of the invention.

FIG. 6 is a flowchart of a rudimentary method, according to an embodiment of the invention.

### DETAILED DESCRIPTION OF THE DRAWINGS

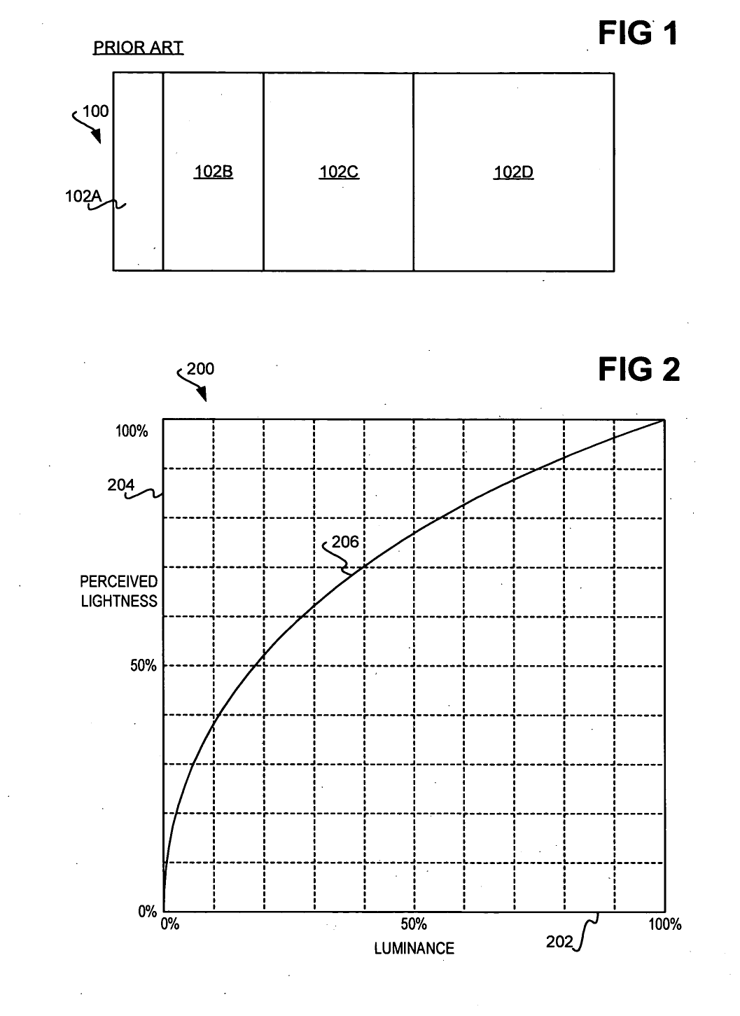

FIG. 1 shows a cross-sectional top view of a display element 100 that corresponds to a pixel of a display, according to the prior art. The display element 100 is divided into a number of different sub-pixel regions 102A, 102B, 102C, and 102D, collectively referred to as the sub-pixel regions 102. In FIG. 1, at any given time at most one of the sub-pixel regions 102 is turned on to provide the display element 100 with a given luminance. The luminance of one of the sub-pixel regions 102 is proportional to the area of that sub-pixel region.

Where the sub-pixel region 102A has an area A, the sub-pixel region 102B has an area 2A, the sub-pixel region 102C has an area 3A, and the sub-pixel region 102D has an area 4A. Therefore, maximum luminance of the display element 100 is provided by the sub-pixel region 102D being turned on, since in FIG. 1, at any given time at most one of the sub-pixel regions 102 is turned on. Where this maximum luminance of the element 100 is L, the luminance of the element 100 provided by the sub-pixel region 102C being turned on is 3L/4, the luminance provided by the sub-pixel region 102B being turned on is L/2, and the luminance provided by the region 102A being turned on is L/4.

Therefore, within the prior art, four equally spaced luminance levels are provided by the sub-pixel regions 102 of the display element 100. Where it is presumed that the human visual system (HVS) perceives each luminance level at a proportionally corresponding lightness level, the display element 100 of the prior art should provide for the display element 100 having equally spaced HVS perceived lightness levels. However, in fact, the human eye does not perceive each luminance level at a proportionally corresponding lightness level.

FIG. 2 shows a graph 200 of HVS perceived lightness as a function of luminance. The x-axis 202 of the graph 200 denotes luminance from 0% to 100%, whereas the y-axis 204 of the graph 200 denotes HVS perceived lightness from 0% to 100%. Thus, the line 206 on the graph 200 shows the lightness of a display element as perceived by the human eye, along the y-axis 204, for a given actual luminance of the display element, along the-x-axis 202. It is noted that the curve depicted in the graph 200 is an exemplary HVS response curve. Based on different viewing environments, and different types of display elements, the graph 200 can be different than that depicted in FIG. 2, as can be appreciated by those of ordinary skill within the art.

With respect to the prior art display element 100 of FIG. 1, where just the sub-pixel region 102A is turned on, to achieve 25% of the maximum luminance, the human eye actually perceives that more than 55% of the maximum lightness is being displayed. Where just the sub-pixel region 102B is turned on, to achieve 50% of the maximum luminance, the human eye actually perceives that more than 75% of the maximum lightness is being displayed. Where just the sub-pixel region 102C is turned on, to achieve 75% of the maximum luminance, the human eye actually perceives that nearly 90% of the maximum lightness is being displayed. Where just the sub-pixel region 102D is turned on, to achieve 100% of the maximum luminance, the human eye by definition perceives the maximum lightness of the display element 100 is being displayed.

Therefore, where it is presumed that the HVS perceives each luminance level at a proportionally corresponding lightness level, the display element 100 of the prior art is incorrectly considered to provide four equally spaced HVS perceived lightness levels of 25%, 50%, 75%, and 100% of maximum lightness. However, in fact, the display element 100 of the prior art actually provides for HVS perceived lightness levels of about 55%, 75%, 90%, and 100% of maximum lightness. These lightness levels are thus not equally spaced HVS perceived lightness levels. As such, a display device having a number of such display elements as in the prior art will not provide for optimal image quality.

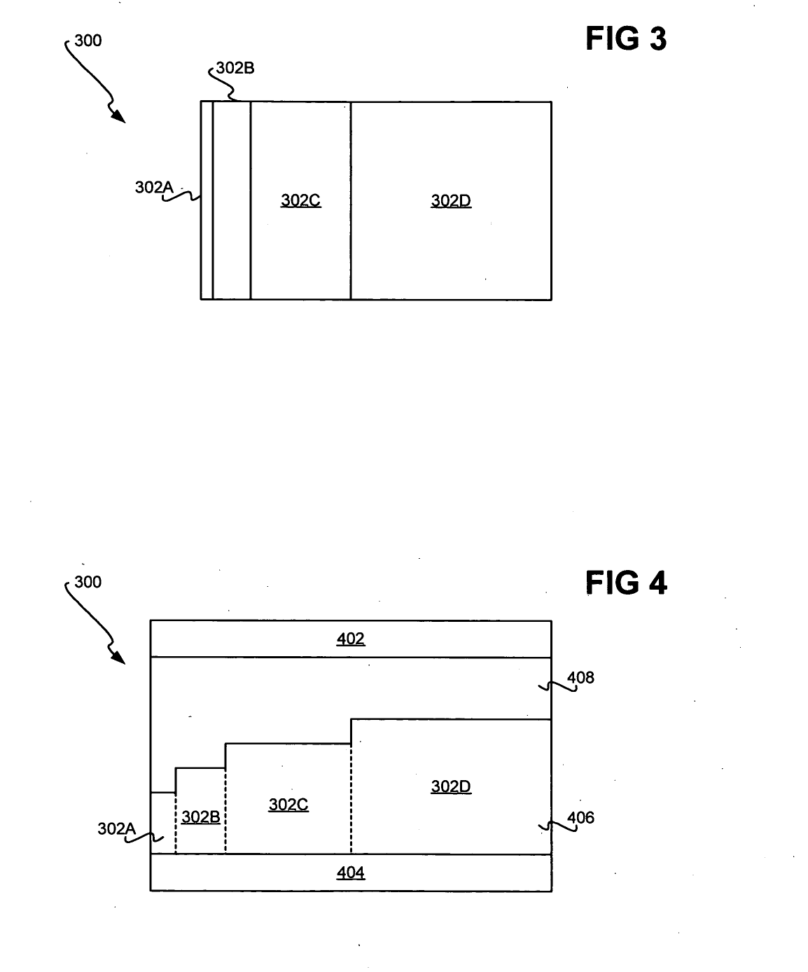

FIG. 3 shows a cross-sectional top view of a display element 300 that corresponds to a pixel of a display, according to an embodiment of the invention. The display element 300 is divided in a number of different sub-pixel regions 302A, 302B, 302C, and 302D, collectively referred to as the sub-pixel regions 302. In the embodiment of FIG. 3, at any given time at most one of the sub-pixel regions 302 is turned on to provide the display element 300 with a given luminance. The luminance of one of the sub-pixel regions 302 is proportional to the area of that sub-pixel region.

The largest sub-pixel region 302D has an area B, and the maximum luminance M of the display element 300 is thus provided by the sub-pixel 302D being turned on, since in the embodiment of FIG. 3, at any given time at most one of the sub-pixel regions 302 is turned on. It is said that the display element 300 has a defined area that is turned on to provide maximum lightness and that encompasses at least one of the areas of the sub-pixel regions 302. In the embodiment of FIG. 3, this defined area is equal to the area of the sub-pixel region 302D, since in this embodiment at any given time at most one of the regions 302 is turned on. Using the graph 200 of FIG. 2, the maximum luminance of the display element 100 as provided by the sub-pixel region 302D provides for the maximum HVS perceived lightness.

The areas of the sub-pixel regions 302A, 302B, and 302C are selected so that they provide luminance levels that equate to substantially equally spaced HVS perceived lightness levels, using the graph 200 of FIG. 2. For instance, the area of the sub-pixel region 302A is about 5% of the area B of the sub-pixel region 302D. While this provides for a luminance that is only 5% of the maximum luminance M provided by the sub-pixel region 302D, the human eye's ability to better discern changes in lower lightness levels means that the sub-pixel region 302A provides for 25% of the maximum HVS perceived lightness provided by the sub-pixel region 302D, using the graph 200.

Likewise, the area of the sub-pixel region 302B is about 18% of the area B of the sub-pixel region 302D. This provides for a luminance that is 18% of the maximum luminance M provided by the sub-pixel region 302D. However, the sub-pixel region 302B provides for 50% of the maximum HVS perceived lightness provided by the sub-pixel region 302D, using the graph 200 of FIG. 2. Finally, the area of the sub-pixel region 302C is about 50% of the area B of the sub-pixel region 302D. This provides for a luminance that is 50% of the maximum luminance M provided by the sub-pixel region 302D. However, the sub-pixel region 302C provides for 75% of the maximum HVS perceived lightness provided by the sub-pixel region 302D, using the graph 200.

Therefore, the areas of the sub-pixel regions 302 are selected so that the ratio of the area of each sub-pixel region to the defined area of the display element 300 itself is such that the display element 300 has a number of substantially equally spaced HVS perceived lightness levels. The “defined area” of the display element 300 is, as has been noted above, the area of the display element 300 that is turned on to provide maximum lightness. In the embodiment of FIG. 3, the defined area of the display element 300 is the area B of the largest sub-pixel region 302D, since in this embodiment just one of the sub-pixel regions 302 is turned on at any given time.

Thus, the areas of the other sub-pixel regions 302A, 302B, and 302C are selected so that they correspond to equally spaced positions along the y-axis 204 of the graph 200 of FIG. 2. When none of the sub-pixel regions 302 are turned on, the display element 300 is said to have no lightness, at the bottom of the y-axis 204. When the sub-pixel region 302D is turned on, the display element 300 is said to have maximum lightness, at the top of the y-axis 204. Therefore, since there are four of the sub-pixel regions 302, the areas of the sub-pixel regions 302A, 302B, and 302C are selected so that they provide for 25%, 50%, and 75% of the maximum lightness, along the y-axis 204.

Because it is assumed that the areas of the sub-pixel regions 302 are directly proportional to the luminance output by that sub-pixel regions when the regions are turned on, the line 206 of the graph 200 of FIG. 2 can be employed to determine the ratio of the area of each sub-pixel region to the defined area of the display element 300. More particularly, the x-axis 204 of the graph 200 can be considered as denoting 0% to 100% of the defined area of the display element 300, in addition to denoting 0% to 100% of luminance of the display element 300. Thus, for the sub-pixel region 302B, for instance, which is to provide 50% HVS perceived lightness, the area of the region 302B is selected so that there is a ratio of about 18% of this area as compared to the defined area of the display element 300.

Stated another way, embodiments of the invention employ the line 206 of the graph 200 to size the areas of the sub-pixel regions 302 of the display element 300 so that the display element 300 has a number of substantially equally spaced HVS perceived lightness levels. The areas of the sub-pixel regions 302 of the display element 300 are not sized so that the display element 300 has a number of equally spaced luminance levels. This is in comparison with the prior art display element 100 of FIG. 1, where the areas of the sub-pixel regions 102 of the display element 100 are sized so that the display element 100 has a number of equally spaced luminance levels, instead of a number of substantially equally spaced HVS perceived lightness levels, as in the display element 300 of FIG. 3.

The embodiment of FIG. 3 thus is such that each of the sub-pixel regions 302 of the display element 300 corresponds to one of the lightness levels of the display element 300. At any give time just one of the sub-pixel regions 302 is turned on to realize a desired lightness level of the display element 300. Not including the zero-lightness level of 0% lightness, there is an equal number of the sub-pixel regions 302 and of the lightness levels of the display element 300. The areas of the sub-pixel regions 302 are further said to be non-linearly ordered in increasing size, in correspondence with these lightness levels being substantially linearly ordered in increasing values as to HVS lightness perception.

FIG. 4 shows a cross-sectional front view of the display element 300, according to another embodiment of the invention. FIG. 4 illustrates how a display element, like the display element 300, can be implemented in one embodiment of the invention. In addition, FIG. 4 illustrates how the display element 300 can have its defined area that is turned on to achieve maximum lightness encompass the areas of more than one of the sub-pixel regions 302, as opposed to just the area of one of the sub-pixel regions 302, as in the embodiment of FIG. 3.

The display element 300 includes a top electrode 402 and a bottom electrode 404. Between the electrodes 402 and 404 are a conductive layer 406 and a liquid crystal layer 408. The conductive layer 406 may be polyethylenedioxythiophene (PEDOT), or another type of conductive layer. The liquid crystal layer 408 may be a post aligned bi-stable nematic (PABN) liquid crystal layer, or another type of liquid crystal layer. The display element 300 is bi-stable, in that once it has been turned on by applying a voltage between the electrodes 402 and 404, the element 300 remains on, until it is turned off. That is, a voltage does not have to be continually applied between the electrodes 402 and 404 for the element 300 to remain turned on, once the display element 300 has been turned on.

The sub-pixel regions 302 in the embodiment of FIG. 4 are defined by varying the heights of the layers 406 and 408, from top to bottom, along the width of the display element 300, from left to right. The lower the height of a given sub-pixel region, the greater the voltage that is needed to be applied between the top and the bottom electrodes 402 and 404 to turn on that sub-pixel region. Thus, the sub-pixel regions 302A, 302B, 302C, and 302D have turn-on voltage thresholds VA, VB, VC, and VD, respectively, where VA>VB>VC>VD. Therefore, a given applied voltage V between the electrodes 402 and 404 turns on all the sub-pixel regions having voltage thresholds equal to or less than the voltage V.

If a voltage V is applied between the electrodes 402 and 404, where VB<=V<VC, then just the sub-pixel region 302D is turned on. If the voltage V is applied, where VC<=V<VB, then the sub-pixel regions 302D and 302C are turned on. If the voltage V is applied, where VB<=V<VA, then the sub-pixel regions 302D, 302C, and 302B are turned on. If the voltage V is applied, where V=>VA, then all of the sub-pixel regions 302 are turned on.

As such, then, there are four different luminance levels associated with the display element 300 in the embodiment of FIG. 4. The first luminance level is directly proportional to the area of the sub-pixel region 302A. The second luminance level is directly proportional to the areas of the sub-pixel regions 302A and 302B in combination. The third luminance level is directly proportional to the areas of the sub-pixel regions 302A, 302B, and 302C in combination. The fourth luminance level is directly proportional to the areas of all the sub-pixel regions 302 in combination.

Therefore, the maximum luminance level of the display element 300 in the embodiment of FIG. 4, which corresponds to the maximum HVS perceived lightness level of the display element 300 in this embodiment, results from all four of the sub-pixel regions 302 being turned on. The defined area of the display element 300 is that which is turned on to provide maximum lightness thus encompasses the areas of all four of the sub-pixel regions 302. The ratio of the area of each individual sub-pixel region to this defined area is again selected to provide for the display element 300 having substantially equally spaced HVS perceived lightness levels.

Using the graph 200 of FIG. 2, the ratios of the areas of the sub-pixel regions 302A, 302B, 302C, and 302D to the defined area of the display element 300 are about 5%, 13%, 32%, and 50%, respectively. At the first luminance level, where just the sub-pixel region 302A is turned on, the 5% of maximum luminance provides for 25% of the maximum HVS perceived lightness. At the second luminance level, where the sub-pixel regions 302A and 302B are turned on, the 5%+13%=18% of maximum luminance provides for 50% of the maximum HVS perceived lightness. At the third luminance level, where the regions 302A, 302B, and 302C are turned on, the 5%+13%+32%=50% of maximum luminance provides for 75% of the maximum HVS perceived lightness. At the fourth luminance level, where all the regions are turned on, the 5%+13%+32%+50%=100% of maximum luminance provides for 100% of the maximum HVS perceived lightness.

Therefore, the display element 300 in the embodiment of FIG. 4 differs from the display element 300 in the embodiment of FIG. 3 in that in the latter embodiment, at most one of the sub-pixel regions 302 can be turned on, whereas in the former embodiment, more than one of the sub-pixel regions 302 can be turned on as has been described. As a result, the ratios of the areas of the sub-pixel regions to the defined area of the display element 300 that provides maximum lightness are selected differently in these two embodiments. Furthermore, the defined area of the display element 300 encompasses differing areas of the sub-pixel regions 302 in these two embodiments.

For instance, in the embodiment of FIG. 3, the defined area of the display element 300 encompasses just the area of the sub-pixel region 302D. The areas of the sub-pixel regions 302A, 302B, and 302C are then selected so that they have ratios of 5%, 18%, and 50% of this defined region. By comparison, in the embodiment of FIG. 4, the defined area of the display element 300 encompasses the areas of all the sub-pixel regions 102. The areas of the sub-pixel regions 302A, 302B, 302C, and 302D are selected so that they have ratios of 5%, 13%, 32%, and 50% of this defined region.

Furthermore, in the embodiment of FIG. 4, the sub-pixel regions 302 in various combinations correspond to the different lightness levels of the display element 300. At any given time, one or more of the sub-pixel regions 302 are turned on in these different combinations to realize a desired lightness level of the display element 300. The number of sub-pixel regions 302 is equal to the number of HVS perceived lightness levels of the display element 300, not including the zero-lightness level of 0% lightness. The areas of these combinations of the sub-pixel regions 302 are non-linearly ordered in increasing size in correspondence with the lightness levels of the display element 300 being linearly ordered in increasing values as to HVS lightness perception.

Other embodiments of the invention can utilize different combinations of sub-pixel regions of a display element as corresponding to the different lightness levels of the display element, beyond that which has been shown in FIG. 4. For example, there may be three sub-pixel regions which can be turned on and off in the following eight combinations: (off, off, off), (on, off, off), (off, on, off), (on, on, off), (off, off, on), (on, off, on), (off, on, on), and (on, on, on). By comparison, if three sub-pixel regions instead subscribed to the approach described in relation to FIG. 4, there would only be four different combinations: (off, off, off), (on, off, off), (on, on, off), and (on, on, on).

Therefore, where there are X sub-pixel regions that can be turned on and off in 2^{X} different combinations, the number of the sub-pixel regions is less than the number of HVS perceived lightness levels of the display element itself, which themselves correspond to the different combinations of the sub-pixel regions. The defined area of the display element that is turned on to provide maximum lightness encompasses the areas of all the sub-pixel regions, and corresponds to the combination where all the sub-pixel regions are turned on. As before, however, the ratio of the area of each sub-pixel region to this defined area is still selected so that the display element has a number of equally spaced HVS perceived lightness levels.

The embodiments of the invention that have been described thus far presume a display element technology that actually provides for zero HVS perceived lightness where none of the sub-pixel regions of the display element are turned on. However, in actuality, with many types of display element technologies, even where none of the sub-pixel regions of a display element are turned on, there is still some light emanating from the display element, such that the HVS perceived lightness is not actually zero. For instance, many display element technologies employ backlighting, which can raise the HVS perceived lightness “floor,” or the minimum HVS perceived lightness, when none of the sub-pixel regions are turned on.

In addition, the embodiments that have been described thus far presume an environment in which there is no ambient light, such-that there will be zero HVS perceived lightness where none of the sub-pixel regions of a display element are turned on. However, in actuality, there is typically some ambient light within a given environment in which a display device is being used. Therefore, even where none of the sub-pixel regions of a display element of the display device are turned on, and even where there is no light emanating from the display element, HVS perceived lightness may not actually be zero due to this ambient light. As before, the HVS perceived lightness “floor,” or the minimum HVS perceived lightness, is increased, even when none of the sub-pixel regions are turned on.

Therefore, in one embodiment, the ratios of the areas of the sub-pixel regions of a display element to the defined area of the display element are selected to provide for the display element having a number of substantially equally spaced HVS perceived lightness levels, while taking into account the actual reduced contrast of the display element that results from either of these two situations. That is, that the HVS,perceived lightness minimum or floor may be greater than zero due to inherent limitations of the display element itself, and/or due to ambient light conditions of the invention in which the display element is typically going to be used, may be accounted for when sizing the areas of the sub-pixel regions of the display element.

For example, the HVS perceived lightness minimum or floor may be set at a level higher than 0% of the maximum lightness, as desired. If the HVS perceived lightness minimum or floor is set to 5% of the maximum lightness, for instance, then the equally spaced HVS perceived lightness levels of the embodiments of FIGS. 3 and 4 would be at 5%, 28.75%, 52.5%, 76.25%, and 100%, instead of at 0%, 25%, 50%, 75%, and 100%, as has been described. Each of the HVS perceived lightness levels, except for the maximum HVS lightness level which remains at 100%, is thus adjusted upwards where the actual reduced contrast is taken into account. As a result, the areas of the sub-pixel regions of the display element would be sized differently than has been described in relation to FIGS. 3 and 4, to achieve these adjusted HVS perceived lightness levels that take into account the actual reduced contrast of the display element.

In general, where E levels of HVS perceived lightness can be achieved, not including the minimum HVS perceived lightness level, and if actual reduced contrast of the display element is not to be taken into account, then the areas of the sub-pixel regions are sized so that the HVS perceived lightness levels are substantially equally spaced apart by a lightness differential of 100%/E. Thus, in the embodiments of FIGS. 3 and 4, where actual reduced contrast of the display element was not taken into account, and there are four such levels of HVS perceived lightness, not including the minimum HVS perceived lightness level, the HVS perceived lightness levels are equally spaced apart by a lightness differential of 25%.

By comparison, where E levels of HVS perceived lightness can be achieved, not including the minimum HVS perceived lightness level, and if actual reduced contrast of the display element is to be taken into account, then the areas of the sub-pixel regions are sized so that the HVS perceived lightness levels are substantially equally spaced apart by a lightness differential of (100%−F)/E. Here, F is the HVS perceived lightness minimum or floor that takes into account the actual reduced contrast of the display element. Therefore, if F is 5% of maximum lightness, and there are four levels of HVS perceived lightness, not including the minimum HVS perceived lightness level, the HVS perceived lightness levels are equally spaced apart by a lightness differential of (100%−5%)/4=23.75%.

Furthermore, while the two embodiments of the invention described in relation to FIGS. 3 and 4 provide two ways in which sub-pixel regions can be turned on to achieve different HVS perceived lightness levels, other embodiments of the invention may employ different approaches. In FIG. 3, for instance, at most one of the sub-pixel regions can be turned on. By comparison, in FIG. 4, sub-pixel regions are turned on sequentially, such that the first region may be turned on, both the first and the second regions may be turned on, the first, second, and third regions may be turned on, and so on. However, in other embodiments, different sub-pixel regions may be turned on in ways other than that which has been described in relation to FIGS. 3 and 4. As has been described, in one example, any combination of the sub-pixel regions may be turned on, as opposed to just sequential combinations as in FIG. 4. In such an embodiment, if there are three sub-pixel regions, then this means that there are 2³=eight different HVS perceived lightness levels.

In addition, the manner by which the various sub-pixel regions of a given display element are addressable to turn on one or more of the regions is not limited by embodiments of the invention. For instance, there may be two common electrical lines that are coupled to all the sub-pixel regions of a display element. In such instance, different voltages applied between the lines may select which of the sub-pixel regions are turned on. As another example, there may be two electrical lines for each sub-pixel regions of a display element. In such an example, a given voltage is applied between the lines of each sub-pixel region that is to be turned on.

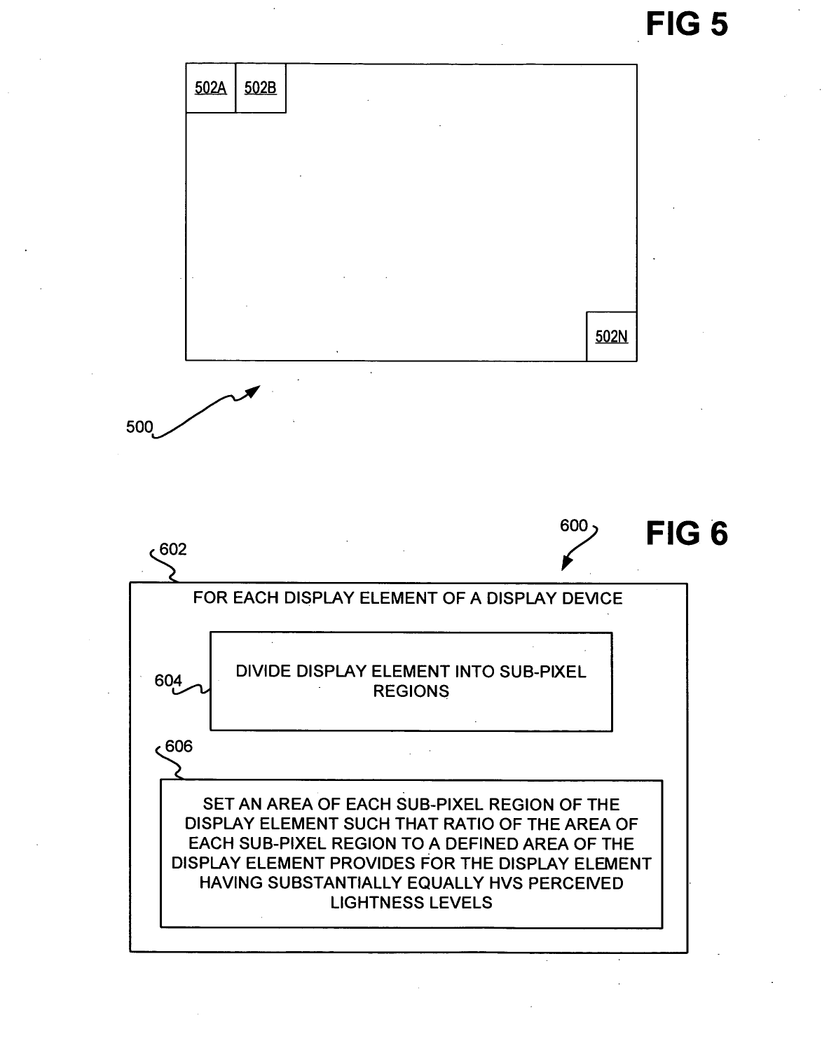

FIG. 5 shows a representative display device 500, according to an embodiment of the invention. The display device 500 includes a number of display elements 502A, 502B, . . . , 502N, collectively referred to as the display elements 502, and which corresponds to the pixels of the display device 500. As can be appreciated by those of ordinary skill within the art, the display device 500 typically includes other components, besides the display elements 502.

Each of the display elements 502 can be implemented as the display element 302 of FIG. 3 or FIG. 4 that has been described. The display elements 502 can be bi-stable display elements, such that they retain their current states being displayed even if power is removed from the elements 502. Thus, power is needed only to change the states of the display elements 502, and not to retain the states of the display elements 502.

Each of the display elements 502 in one embodiment may correspond to a single color of the pixel to which it corresponds. For instance, one of the display elements 502 may correspond to the color red of a given pixel, another of the display elements 502 may correspond to the color green of that pixel, and a third of the display elements 502 may correspond to the color blue of that pixel. In another embodiment, each of the display elements 502 corresponds in whole to a pixel of the display device 500 in full color. Thus, the sub-pixel regions of a given display element include red sub-pixel regions, green sub-pixel regions, and blue sub-pixel regions.

FIG. 6 shows a rudimentary method 600, according to an embodiment of the invention. As indicated by part 602 of the method 600, the method 600 is performed for each display element of a display device that corresponds to a pixel of the display device. The display element is effectively divided into a number of sub-pixel regions (604). As has been described, each sub-pixel region is considered as having two states, an on state and an off state. In its on state, a sub-pixel region contributes to the overall luminance and lightness of the display element of which it is a part. In its off state, a sub-pixel region does not contribute to the overall luminance and lightness of the display element of which it is a part.

The area of each sub-pixel region is set, or specified, such that the ratio of the area of each sub-pixel region to the defined area of the display element overall, as has been described, provides for the display element having substantially equally HVS perceived lightness levels (606). The area of each sub-pixel region may be set or specified in one embodiment as has been described in relation to FIG. 3. In another embodiment, the area of each sub-pixel region may be set or specified as has been described in relation to FIG. 4.

It is noted that embodiments of the invention provide for advantages over other approaches to achieve substantially equal HVS perceived lightness levels. In particular, embodiments of the invention achieve substantially equal HVS perceived lightness levels by appropriately designing the sub-pixel regions of the display elements of a display device. During design and manufacture, each sub-pixel region of a display element has its area set or specified so that substantially equal HVS perceived lightness levels of the display element result.

Therefore, during usage of such a display device, no concern needs to be provided as to translating luminance levels to achieve substantially equal HVS perceived lightness levels. Rather, such substantially equal HVS perceived lightness levels are “built into” the display device itself. As such, additional programming of the driver circuitry, and so on, of a display device in accordance with an embodiment of the invention, to provide for substantially equal HVS perceived lightness levels, does not have to be performed.

We claim:

1. A display element corresponding to a pixel of a display, comprising:
a plurality of sub-pixel regions, each sub-pixel region having two states including an on state and an off state, and each sub-pixel region having an area, the display element having a defined area that is turned on to provide maximum lightness and that encompasses at least one the areas of the sub-pixel regions,
wherein a ratio of the area of each sub-pixel region to the defined area of the display element is selected to provide for the display element having a plurality of substantially equally spaced human visual system (HVS) perceived lightness levels.

2. The display element of claim 1, wherein the area of each of one or more of the sub-pixel regions is different than the area of each of one or more other of the sub-pixel regions.

3. The display element of claim 1, wherein each sub-pixel region corresponds to one of the lightness levels of the display element, such that at any given time at most one of the sub-pixel regions is turned on to realize a desired one of the lightness levels of the display element, and such that there are an equal number of the sub-pixel regions and of the lightness levels of the display element.

4. The display element of claim 3, wherein the areas of the sub-pixel regions are non-linearly ordered in increasing size in correspondence with the lightness levels of the display element being substantially linearly ordered in increasing values as to HVS lightness perception.

5. The display element of claim 1, wherein the sub-pixel regions in various combinations correspond to the lightness levels of the display element, such that at any given time one or more of the sub-pixel regions are turned on in different combination to realize a desired one of the lightness levels of the display element.

6. The display element of claim 5, wherein the sub-pixel regions are organized in a plurality of non-exclusive combinations corresponding, in number to the lightness levels of the display element, each combination having an area encompassing the areas of the sub-pixel regions of the combination,
and wherein the areas of the combinations are non-linearly ordered in increasing size in correspondence with the lightness levels of the display element being substantially linearly ordered in increasing values as to HVS lightness perception.

7. The display element of claim 1, wherein the ratio of the area of each sub-region to the defined area of the display element is further selected to provide for the display element having the plurality of substantially equally spaced HVS perceived lightness levels while taking into account actual reduced contrast of the display element due to either actual ambient light conditions of an environment in which the display is used, or inherent limitations of the display element itself, or both.

8. The display element of claim 7, wherein each of at least one of the lightness levels is adjusted upwards to take into account the actual reduced contrast of the display element, as compared to the lightness level where the actual reduced contrast of the display element is not taken into account.

9. The display element of claim 1, wherein the display element is a bi-stable display element.

10. The display element of claim 1, wherein the display element corresponds to a single color of the pixel of the display, as one of red, green, and blue.

11. The display element of claim 1, wherein the display element corresponds in whole to the pixel of the display in full color, such that the sub-pixel regions include red sub-pixel regions, green sub-pixel regions, and blue sub-pixel regions.

12. A display device comprising:
a plurality of display elements corresponding to a plurality of pixels of the display device, each display element comprising:
a plurality of sub-pixel regions, each sub-pixel region having two states including an on state and an off state, and each sub-pixel region having an area, the display element having a defined area that is turned to provide maximum lightness and that encompasses at least one of the areas of the sub-pixel regions,
wherein a ratio of the area of each sub-pixel region to the defined area of the display element is selected to provide for the display element having a plurality of substantially equally spaced human visual system (HVS) perceived lightness levels

13. The display device of claim 12, wherein the area of each of one or more of the sub-pixel regions of each display element is different than the area of each of one or more other of the sub-pixel regions of the display element.

14. The display device of claim 12, wherein each sub-pixel region of each display element corresponds to one of the lightness levels of the display element, such that at any given time at most one of the sub-pixel regions is turned on to realize a desired one of the lightness levels of the display element, and such that there are an equal number of the sub-pixel regions and of the lightness levels of the display element.

15. The display device of claim 12, wherein the sub-pixel regions of each display element in various combinations correspond to the lightness levels of the display element, such that at any given time one or more of the sub-pixel regions are turned on in different combination to realize a desired one of the lightness levels of the display element.

16. The display device of claim 12, wherein the ratio of the area of each sub-region of each display element to the defined area of the display element is further selected to provide for the display element having the plurality of substantially equally spaced HVS perceived lightness levels while taking into account actual reduced contrast of the display element due to either actual ambient light conditions of an environment in which the display is used, or inherent limitations of the display element itself, or both.

17. A method comprising:
for each display element of a plurality of display elements of a display device corresponding to a plurality of pixels of the display device,
dividing the display element into a plurality of sub-pixel regions, each sub-pixel region having two states including an on state and an off state; and,
setting an area of each sub-pixel region of the display element, the display element having a defined area that is turned on to provide maximum lightness and that encompasses at least one of the areas of the sub-pixel regions, such that a ratio of the area of each sub-pixel region to the defined area of the display element provides for the display element having a plurality of substantially equally spaced human visual system (HVS) perceived lightness levels.

18. The method of claim 17, wherein setting the area of each sub-pixel region of the display element is such that each sub-pixel region corresponds to one of the lightness levels of the display element, such that at any given time at most one of the sub-pixel regions is turned on to realize a desired one of the lightness levels of the display element, and such that there are an equal number of the sub-pixel regions and of the lightness levels of the display element.

19. The method of claim 17, wherein setting the area of each sub-pixel region of the display element is such that the sub-pixel regions in various combinations correspond to the lightness levels of the display element, such that at any given time one or more of the sub-pixel regions are turned on in different combination to realize a desired one of the lightness levels of the display element.

20. The method of claim 17, wherein setting the area of each sub-pixel region of the display element is such that the ratio of the area of each sub-region to the defined area of the display element is further to provide for the display element having the plurality of substantially equally spaced HVS perceived lightness levels while taking into account actual reduced contrast of the display element due to either actual ambient light conditions of an environment in which the display is used, or inherent limitations of the display element itself or both.
